(19) United States
(12) Patent Application Publication
(10) Pub. No.: US 2025/0055129 A1
(43) Pub. Date: Feb. 13, 2025

(54) POLYMER SEPARATOR WITH IMPROVED CHARGE/DISCHARGE PERFORMANCE AND THERMAL STABILITY, METHOD FOR FABRICATING THE SAME, AND ELECTROCHEMICAL DEVICE COMPRISING THE SAME

(71) Applicant: Pukyong National University Industry-University Cooperation Foundation, Busan (KR)

(72) Inventors: Kie Yong CHO, Busan (KR); Jae Won PARK, Busan (KR); Young Je KWON, Busan (KR); Min Jeong LEE, Busan (KR); Gyeong Min CHOI, Busan (KR)

(73) Assignee: Pukyong National University Industry-University Cooperation Foundation, Busan (KR)

(21) Appl. No.: 18/785,705

(22) Filed: Jul. 26, 2024

(30) Foreign Application Priority Data
Aug. 4, 2023 (KR) 10-2023-0101976

(51) Int. Cl. H01M 50/446; H01M 10/0525; H01M 50/403; H01M 50/426; H01M 50/434; H01M 50/443; H01M 50/449

(52) U.S. Cl. CPC H01M 50/446; H01M 50/403; H01M 50/426; H01M 50/434; H01M 50/443; H01M 50/449; H01M 10/0525

(57) ABSTRACT

A polymer separator with improved charge and discharge performance and thermal stability, includes a porous polymer substrate and a coating layer formed on at least one surface of the porous polymer separator. The coating layer includes: functional group bonded to double bond-containing PVDF (DPVDE); and inorganic oxide particles bonded to the functional group.

### CROSS-REFERENCE TO PRIOR APPLICATION

This Application claims priority to Korean Patent Application No. 10-2023-0101976 (filed on Aug. 4, 2023), which is hereby incorporated by reference in its entirety.

### BACKGROUND

The present disclosure relates to a polymer separator with improved charge/discharge performance and thermal stability, a method for fabricating the same, and an electrochemical device comprising the same, and more specifically, to a polymer separator with improved charge/discharge performance and thermal stability, fabricated by dip-coating a porous polymer substrate with double bond-containing PVDF (DPVDF), followed by introduction of a functional group and coating with inorganic oxide particles, a method for fabricating the same, and an electrochemical device comprising the same.

Recently, the demand for large-capacity batteries has rapidly increased due to the increased demand for electric vehicles and portable electronic devices. To produce a large-capacity battery, a cathode (positive electrode), an anode (negative electrode), an electrolyte, and a separator are required. The cathode is a source of lithium ions that determines the capacity and average voltage of the battery, and the anode stores and releases lithium ions from the cathode, allowing current to pass through an external circuit. In addition, the separator serves to prevent the cathode and the anode from contacting each other. Therefore, in order to produce large-capacity batteries, the use of a cathode with a high theoretical capacity is important, but an anode material that can support the same is also very important.

Although a graphite-based anode is currently used, lithium metal anode materials are attracting attention as next-generation anode materials. However, lithium metal is susceptible to lithium dendrite formation, which is considered the main cause of battery fires. The lithium dendrite formation refers to a phenomenon in which lithium crystals form on the surface of the anode during the charging of a lithium-ion battery, become nuclei, and pile up sharply like tree branches.

Although lithium metal has a higher fire risk than other anode materials, it has the lowest redox potential among metal elements and exhibits excellent characteristics in terms of capacity and operating voltage when used as an anode material. Therefore, if lithium metal is used as an anode material while a separator having improved thermal and mechanical stability is used, the risk of battery fires will be reduced along with the excellent effect of lithium metal as an anode material.

### PRIOR ART DOCUMENTS

Korean Patent No. 10-1865393

### SUMMARY

An object of the present disclosure is to provide a polymer separator that has enhanced electrolyte affinity as a result of dip-coating a porous polymer substrate with double bond-containing PVDF (DPVDF), and has improved charge/discharge performance and thermal stability as result of introducing a functional group capable of bonding to inorganic oxide particles to the substrate and then coating the substrate with inorganic oxide particles.

Another object of the present disclosure is to provide a method for fabricating a polymer separator that has enhanced electrolyte affinity as a result of dip-coating a porous polymer substrate with double bond-containing PVDF (DPVDF), and has improved charge/discharge performance and thermal stability as result of introducing a functional group capable of bonding to inorganic oxide particles to the substrate and then coating the substrate with inorganic oxide particles.

Still another object of the present disclosure is to provide an electrochemical device that has a reduced risk of battery fire by comprising the polymer separator.

Objects to be achieved by the present disclosure are not limited to the objects mentioned above, and other objects not mentioned above can be clearly understood by those skilled in the art from the following description.

To achieve the above objects, the present disclosure provides a polymer separator comprising a porous polymer substrate and a coating layer formed on at least one surface of the porous polymer separator, wherein the coating layer comprises: a functional group bonded to double bond-containing PVDF (DPVDF); and inorganic oxide particles bonded to the functional group.

In the present disclosure, the functional group may be at least one compound selected from the group consisting of compounds represented by Formulas 1 to 4 below:

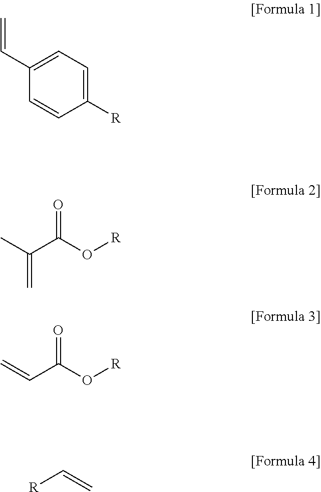

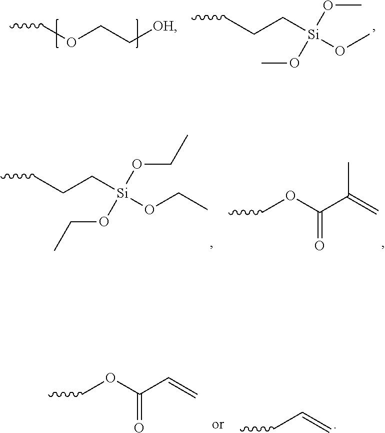

In Formulas 1 to 4 above, R may be

In the present disclosure, the porous polymer substrate may comprise at least one selected from the group consisting of polyethylene (PE), polypropylene (PP), cellulose acetate, polyvinylidene fluoride (PVDF), polyethersulfone (PES), and polyethylene terephthalate (PET).

In the present disclosure, the inorganic oxide particles may comprise at last one type of inorganic oxide particles selected from the group consisting of silicon dioxide (SiO₂) nanoparticles, aluminum oxide (Al₂O₃) nanoparticles, and titanium dioxide (TiO₂) nanoparticles.

In the present disclosure, the coating layer may have a thickness of 180 to 260 nm.

The present disclosure also provides an electrochemical device comprising the polymer separator according to the present disclosure.

In the present disclosure, the electrochemical device may be a lithium-ion battery.

The present disclosure also provides a method for fabricating a polymer separator, comprising steps of: dip-coating a porous polymer substrate with double bond-containing PVDF (DPVDF); introducing at least one functional group, selected from the group consisting of polyethyleneglycol methacrylate (PEGMA), 3-(trimethoxysilyl)propyl acrylate (TMSA), and ethylene glycol dimethacrylate (EGDMA), to the dip-coated substrate; and coating the substrate, to which the functional group has been introduced, with inorganic oxide particles.

In the present disclosure, the step of introducing the functional group may be a step of immersing the dip-coated substrate in solution a containing polyethyleneglycol methacrylate (PEGMA), 3-(trimethoxysilyl)propyl acrylate (TMSA), and ethylene glycol dimethacrylate (EGDMA), wherein the solution may be a solution containing the PEGMA at a concentration of 0.05 to 0.14 M, the TMSA at a concentration of 0.1 to 0.3 M, and the EGDMA at a concentration of 0.02 to 0.04 M.

In the present disclosure, the step of coating the substrate with the inorganic oxide particles may comprise casting a solution containing the inorganic oxide particles onto the substrate to which the functional group has been introduced.

In the present disclosure, the porous polymer substrate may comprise at least one selected from the group consisting of polyethylene (PE), polypropylene (PP), cellulose acetate, polyvinylidene fluoride (PVDF), polyethersulfone (PES), and polyethylene terephthalate (PET).

In the present disclosure, the inorganic oxide particles may comprise at last one type of inorganic oxide particles selected from the group consisting of silicon dioxide (SiO₂) nanoparticles, aluminum oxide (Al₂O₃) nanoparticles, and titanium dioxide (TiO₂) nanoparticles.

The present disclosure may provide a polymer separator that has enhanced electrolyte affinity as a result of dip-coating a porous polymer substrate with double bond-containing PVDF (DPVDF), and has improved charge/discharge performance and thermal stability as result of introducing a functional group capable of bonding to inorganic oxide particles to the substrate and then coating the substrate with inorganic oxide particles.

The present disclosure may also provide a method for fabricating a polymer separator that has enhanced electrolyte affinity as a result of dip-coating a porous polymer substrate with double bond-containing PVDF (DPVDF), and has improved charge/discharge performance and thermal stability as result of introducing a functional group capable of bonding to inorganic oxide particles to the substrate and then coating the substrate with inorganic oxide particles.

The present disclosure may also provide an electrochemical device that has a reduced risk of battery fire by comprising the polymer separator.

Effects of the present disclosure are not limited to the effects mentioned above, and other effects not mentioned above may be clearly understood by those skilled in the art from the appended claims.

### BRIEF DESCRIPTION OF THE DRAWINGS

FIG. 1 schematically shows a method for fabricating a polymer separator of the present disclosure.

FIG. 2 schematically shows a method for fabricating a polymer separator of the present disclosure.

FIG. 3 shows the types of functional groups that may be introduced to the polymer separator of the present disclosure.

FIG. 4 shows the results of analyzing the surface properties, water contact angle, thermal properties, and pore shape and size of a separator dip-coated with DPVDF.

FIG. 5 shows the results of analyzing the FT-IR peaks and pore shapes of separators obtained by dip coating with DPVDF and then introducing PEGMA, TMSA, and EGDMA as functional groups.

FIG. 6 shows the results of analyzing the electrochemical properties of separators obtained by dip coating with DPVDF and then introducing PEGMA, TMSA, and EGDMA as functional groups.

FIG. 7 shows the results of comparing the average thicknesses and coating uniformities of separators depending on the methods of coating with inorganic oxide particles.

FIG. 8 shows the results of comparing the electrochemical properties of separators obtained by dip coating with DPVDF and introduction of PEGMA, TMSA and EGDMA as functional groups, followed by coating with inorganic oxide particles.

FIG. 9 shows the results of comparing the thermal stabilities of separators obtained by dip coating with DPVDF and introduction of PEGMA, TMSA and EGDMA as functional groups, followed by coating with inorganic oxide particles.

FIG. 10 shows the results of comparing the lithium-ion battery charge/discharge performance of separators obtained by dip coating with DPVDF and introduction of PEGMA, TMSA and EGDMA as functional groups, followed by coating with inorganic oxide particles.

FIG. 11 shows the results of comparing the lithium dendrite resistance of separators obtained by dip coating with DPVDF and introduction of PEGMA, TMSA and EGDMA as functional groups, followed by coating with inorganic oxide particles.

FIG. 12 shows the results of analyzing the pore size and shape of a polymer separator coated with aluminum oxide nanoparticles.

FIG. 13 shows the results of analyzing the pore size and shape of a polymer separator coated with titanium dioxide nanoparticles.

### DETAILED DESCRIPTION

Terms used in the present specification are currently widely used general terms selected in consideration of their functions in the present disclosure, but they may change depending on the intents of those skilled in the art, precedents, or the advents of new technology. Additionally, in certain cases, there may be terms arbitrarily selected by the applicant, are described in a and in this case, their meanings corresponding description part of the present disclosure. Accordingly, terms used in the present disclosure should be defined based on the meaning of the term and the entire contents of the present disclosure, rather than the simple term name.

Unless otherwise defined, all terms used herein, including technical or scientific terms, have the same meanings as understood by those skilled in the art to which the present disclosure pertains. Terms such as those used in general and defined in dictionaries should be interpreted as having meanings identical to those specified in the context of related technology. Unless definitely defined in the present application, the terms should not be interpreted as having ideal or excessively formative meanings.

A numerical range includes numerical values defined in the range. Every maximum numerical limitation given throughout the present specification includes every lower numerical limitation, as if such lower numerical limitations were expressly written herein. Every minimum numerical limitation given throughout the present specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Hereinafter, the present disclosure will be described in detail.

### Polymer Separator

The present disclosure provides a polymer separator comprising a porous polymer substrate and a coating layer formed on at least one surface of the porous polymer separator, wherein the coating layer comprises: a functional group bonded to double bond-containing PVDF (DPVDF); and inorganic oxide particles bonded to the functional group.

In the present disclosure, the porous polymer substrate may comprise at least one selected from the group consisting of polyethylene (PE), polypropylene (PP), cellulose acetate, polyvinylidene fluoride (PVDF), polyethersulfone (PES), and polyethylene terephthalate (PET). Preferably, the porous polymer substrate may comprise at least one selected from the group consisting of polypropylene (PP) and polyethylene (PE). More preferably, the porous polymer substrate may comprise polypropylene (PP).

In the present disclosure, the functional group may provide sites to which the inorganic oxide particles can bond. The functional group may be at least one compound selected from the group consisting of compounds represented by Formulas 1 to 4 below:

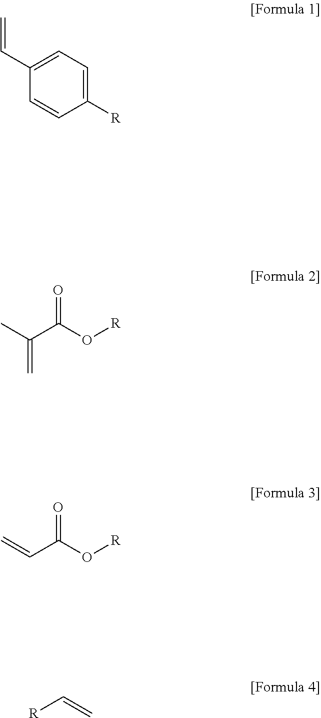

In Formulas 1 to 4 above, R may be

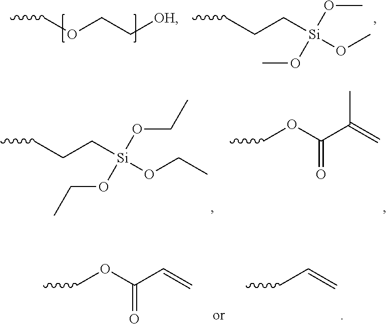

Preferably, the functional group may be at least one functional group selected from the group consisting of polyethyleneglycol methacrylate (PEGMA), 3-(trimethoxysilyl)propyl acrylate (TMSA), and ethylene glycol dimethacrylate (EGDMA). More preferably, the functional group may comprise all of polyethyleneglycol methacrylate (PEGMA), 3-(trimethoxysilyl)propyl acrylate (TMSA), and ethylene glycol dimethacrylate (EGDMA).

In the present disclosure, the polyethylene glycol methacrylate (PEGMA) may be a compound represented by Formula 5 below. In addition, the PEGMA may have a number-average molecular weight (Mₙ) of 360.

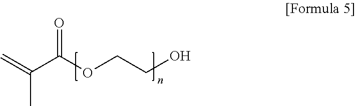

In Formula 5 above, n may be 3 to 6, preferably 4 to 5, more preferably 4.5.

In the present disclosure, the 3-(trimethoxysilyl)propyl acrylate (TMSA) may be a compound represented by Formula 6 below.

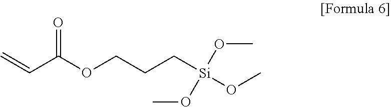

In the present disclosure, the ethylene glycol dimethacrylate (EGDMA) may be a compound represented by Formula 7 below.

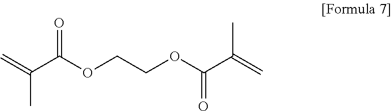

In the present disclosure, the functional group boded to double bond-containing PVDF (DPVDF) may be a compound represented by Formula 8 below.

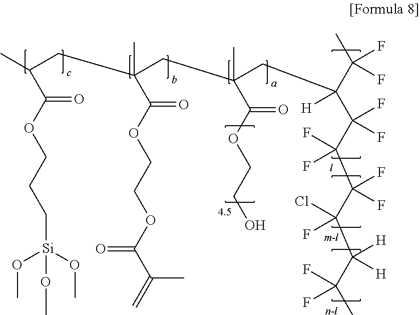

In Formula 8 above, n and m may be each 4,300 to 4,400, preferably 4,330 to 4,370, more preferably 4354. In Formula 8 above, 1 may be 1,000 to 1,100, preferably 1,020 to 1,060, more preferably 1,045. In addition, in Formula 8 above, a may be 20 to 50, b may be 5 to 15, and c may be 60 to 100.

In the present disclosure, the double bond-containing PVDF may be a compound represented by Formula 9 below.

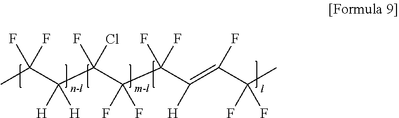

In Formula 9 above, n and m may be each 4,300 to 4,400, preferably 4,330 to 4,370, more preferably 4,354. In Formula 9 above, 1 may be 1,000 to 1,100, preferably 1,020 to 1,060, more preferably 1,045.

In the present disclosure, the inorganic oxide particles may comprise at least one type of inorganic oxide particles selected from the group consisting of silicon dioxide (SiO₂) nanoparticles, aluminum oxide (Al₂O₃) nanoparticles, titanium dioxide (TiO₂) nanoparticles, zinc dioxide ZnO₂) nanoparticles, Iron(III) oxide nanoparticles; iron(III) oxide (Fe₂O₃) nanoparticles, talc, mica, and clay. Preferably, the inorganic oxide particles may comprise at least one type of inorganic oxide particles selected from the group consisting of silicon dioxide (SiO₂) nanoparticles, aluminum oxide (Al₂O₃) nanoparticles, and titanium dioxide (TiO₂) nanoparticles. More preferably, the inorganic oxide particles may be silicon dioxide (SiO₂) nanoparticles, aluminum oxide (Al₂O₃) nanoparticles, or titanium dioxide (TiO₂) nanoparticles.

In the present disclosure, the polymer separator may be used as a separator for an electrochemical device. Preferably, the polymer separator may be used as a separator for a lithium-ion battery.

In the present disclosure, the coating layer of the polymer separator may have a thickness of 180 to 260 nm, preferably 210 to 255 nm.

The present disclosure may also provide an electrochemical device comprising the polymer separator described above. Preferably, the present disclosure may provide a lithium-ion battery comprising the polymer separator described above.

### Method for Fabricating Polymer Separator

The present disclosure may also provide a method for fabricating a polymer separator, comprising steps of: dip-coating a porous polymer substrate with double bond-containing PVDF (DPVDF); introducing at least one functional group, selected from the group consisting of polyethyleneglycol methacrylate (PEGMA), 3-(trimethoxysilyl)propyl acrylate (TMSA), and ethylene glycol dimethacrylate (EGDMA), to the dip-coated substrate; and coating the substrate, to which the functional group has been introduced, with inorganic oxide particles.

In the present disclosure, the porous polymer substrate may comprise at least one selected from the group consisting of polyethylene (PE), polypropylene (PP), cellulose acetate, polyvinylidene fluoride (PVDF), polyethersulfone (PES), and polyethylene terephthalate (PET). Preferably, the porous polymer substrate may comprise at least one selected from the group consisting of polypropylene (PP) and polyethylene (PE). More preferably, the porous polymer substrate may comprise polypropylene (PP).

The step of dip-coating the porous polymer substrate with double bond-containing PVDF (DPVDF) may be a step of dip-coating the porous polymer substrate by dipping the same in a solution containing the DPVDF. The solvent used in the solution containing the DPVDF may preferably be a solvent capable of dissolving the DPVDF. More specifically, the solvent may be acetone or tetrahydrofuran. Most preferably, the solvent may be acetone. The solution containing the DPVDF may be a solution obtained by adding the DPVDF to an acetone solvent at a concentration of 0.5 to 2.0 wt %, and the step of dip-coating the porous polymer substrate may be a step of dip-coating the porous polymer substrate by dipping the same in a solution, obtained by adding the DPVDF to an acetone solvent at a concentration of 0.5 to 2.0 wt %, for 30 seconds to 2 minutes.

In addition, the step of dip-coating may further comprise a vacuum drying step after the dip coating. Preferably, the step of dip-coating may further comprise a step of vacuum-drying the dip-coated substrate for 2 to 4 hours.

The step of introducing at least one functional group, selected from the group consisting of polyethyleneglycol methacrylate (PEGMA), 3-(trimethoxysilyl)propyl acrylate (TMSA), and ethylene glycol dimethacrylate (EGDMA), to the dip-coated substrate may be a step of introducing, to the substrate, the functional group that provides sites to which the inorganic oxide particles can bond. More preferably, the step may be a step of introducing, to the dip-coated substrate, at least one functional group selected from the group consisting of polyethyleneglycol methacrylate (PEGMA), 3-(trimethoxysilyl)propyl acrylate (TMSA), and ethylene glycol dimethacrylate (EGDMA). More preferably, the step may be a step of introducing, to the dip-coated substrate, polyethyleneglycol methacrylate (PEGMA), 3-(trimethoxysilyl)propyl acrylate (TMSA), and ethylene glycol dimethacrylate (EGDMA).

The step of introducing the functional group may be a step of allowing the dip-coated substrate with a solution containing PEGMA, TMSA and EGDMA at 60 to 80° C. for 3 to 5 hours. The solution containing PEGMA, TMSA and EGDMA may be a solution obtained by adding, to a degassed ethanol solvent, the PEGMA at a concentration of 0.05 to 0.14 M, the TMSA at a concentration of 0.1 to 0.3 M, and the EGDMA at a concentration of 0.02 to 0.05 M. Preferably, the solution containing PEGMA, TMSA and EGDMA may be a solution obtained by adding, to a degassed ethanol solvent, the PEGMA at a concentration of 0.08 to 0.10 M, the TMSA at a concentration of 0.20 to 0.22 M, and the EGDMA at a concentration of 0.02 to 0.04 M.

In addition, the solution containing PEGMA, TMSA and EGDMA may further contain a radical initiator. The radical initiator may be at least one selected from the group consisting of azobisisobutyronitrile (AIBN), benzoyl peroxide (BPO), lauryl peroxide, azobisisocapronitrile, azobisisovaleronitrile, methyl ethyl ketone peroxide (MEKP), potassium persulfate, di-tert-butyl peroxide, and 1,1′-dihydroxydicyclohexyl peroxide. Preferably, the radical initiator may be azobisisobutyronitrile (AlBN). More preferably, the solution containing PEGMA, TMSA and EGDMA may contain the AIBN at a concentration of 0.001 to 0.005 M.

The step of coating the substrate, to which the functional group has been introduced, with inorganic oxide particles may be a step of coating the substrate with inorganic oxide particles after making sites to which the inorganic oxide particles by introduction of the functional group, thereby fabricating a separator with improved charge/discharge performance and thermal stability. Here, the inorganic oxide particles may comprise at least one type of inorganic oxide particles selected from the silicon dioxide (SiO₂) nanoparticles, group consisting of aluminum oxide (Al₂₃) nanoparticles, titanium dioxide (TiO₂) nanoparticles, zinc dioxide Zn₂) nanoparticles, Iron (III) oxide nanoparticles; iron(III) oxide (Fe₂O₃) nanoparticles, talc, mica, and clay. Preferably, the inorganic oxide particles may comprise at least one type of inorganic oxide particles selected from the group consisting of silicon dioxide (SiO₂) nanoparticles, aluminum oxide (Al₂O₃) nanoparticles, and titanium dioxide (TiO₂) nanoparticles. More preferably, the inorganic oxide particles may be silicon dioxide (SiO₂) nanoparticles, aluminum oxide (Al₂O₃) nanoparticles, or titanium dioxide (Ti₂) nanoparticles.

The coating may be performed by placing the substrate, to which the functional group has been introduced, on a glass plate, and casting a solution containing the inorganic oxide particles at a concentration of 0.5 to 2 wt % onto the glass plate. The method may further comprise, after the coating step, a step of drying in an oven at a temperature of 40 to 60° C. for 10 to 14 hours.

The present disclosure may also provide a polymer separator fabricated according to the above-described method for fabricating a polymer separator.

Hereinafter, examples of the present disclosure will be described in detail, but it is obvious that the present disclosure is not limited by the following examples.

### Example 1

### Fabrication of Polymer Separator with Improved Charge/Discharge Performance and Thermal Stability

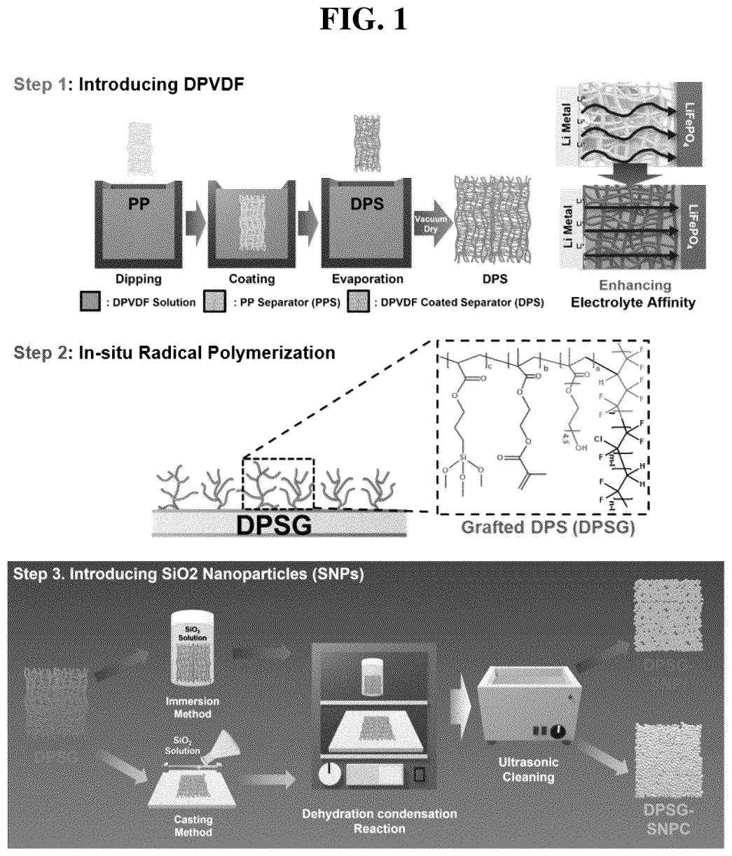

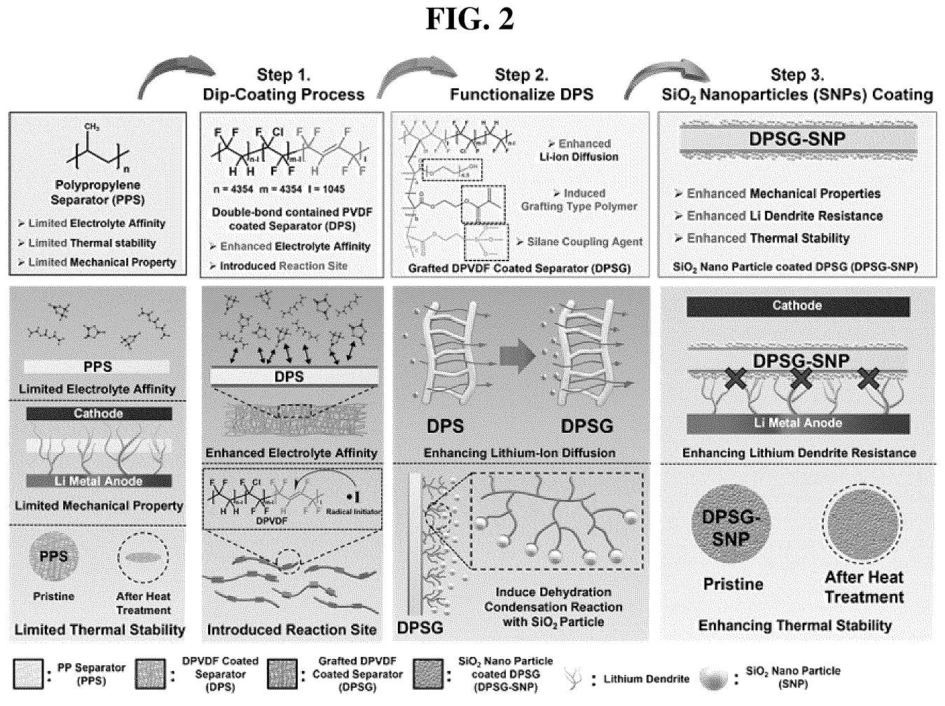

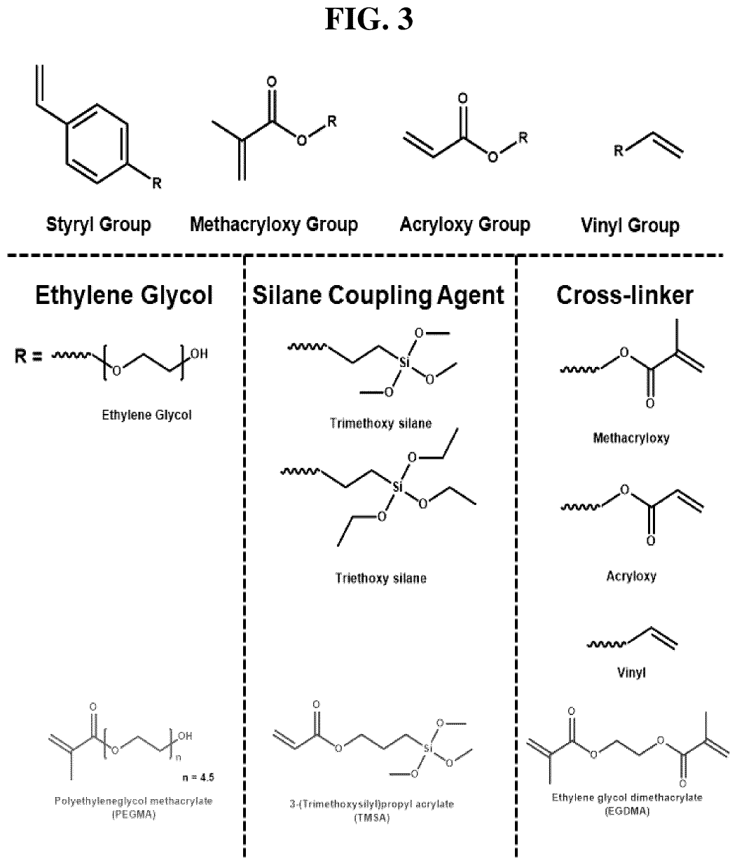

In Example 1, a porous polymer substrate was dip-coated with DPVDF, and a functional group was introduced thereto, followed by coating with inorganic oxide particles. The experimental process of Example 1 is schematically shown in FIGS. 1 and 2.

1-1. Dip-Coating with DPVDF

A polypropylene (PP) separator was prepared as a porous polymer substrate, and a dip-coating solution was prepared for dip-coating the PP separator. The dip-coating solution was prepared by adding double bond-containing PVDF (DPVDF) to an acetone solvent at a concentration of 1 wt %. The PP separator was dipped in the dip-coating solution at room temperature for 1 minute and slowly lifted at an angle of 90°, thereby being coated with a uniform thickness of the DPVDF. Thereafter, the coated separator was vacuum dried in an oven for 3 hours. The PP separator dip-coated with DPVDF was named DPVDF-coated separator (DPS), and the experimental conditions in Example 1-1 are shown in Table 1 below.

TABLE 1

| | | | | Vacuum |
|---|---|---|---|---|
| | | Polymer | Dipping | drying |
| | | concentration | time | time |
| Polymer | Solvent | (wt %) | (min) | (hours) |
| DPVDF | Acetone | 1 | 1 | 3 |

### 1-2. Introduction of Functional Groups

Functional groups capable of bonding to inorganic oxide particles were introduced to the separator dip-coated in Example 1-1. A total of three types of functional groups were introduced in Example 1-2. That is, polyethyleneglycol methacrylate (PEGMA), 3-(trimethoxysilyl)propyl acrylate (TMSA), and ethylene glycol dimethacrylate (EGDMA) were introduced.

First, a solution containing PEGMA, TMSA and EGDMA was prepared. The solution was prepared by adding 0.09 M PEGMA (Mₙ=360), 0.21 M TMSA and 0.03 M EGDMA to 30 ml of degassed ethanol and adding azobisisobutyronitrile (AlBN) as a radical initiator thereto at a concentration of 0.003 M. The separator dip-coated in Example 1-1 was allowed to react with the prepared solution for 4 hours, thereby introducing PEGMA, TMSA and EGDMA functional groups to the separator. The separator to which the PEGMA, TMSA, and EGDMA functional groups have been introduced was named grafted DPS (DPSG), and the experimental conditions in Examples 1-2 are shown in Table 2 below.

TABLE 2

| | | | | Molar | | Conc. of | Monomer: | |
|---|---|---|---|---|---|---|---|---|
| | Temp. | | | conc. of | Radical | radical | AIBN | Reaction |
| Separator | (° C.) | Solvent | Monomer | monomer | initiator | initiator | ratio | time |
| DPS | 70 | 50 ml of | PEGMA | 0.09M | AIBN | 0.003M | 30 | 4 hours |
| | | degassed | (Mn = | | | | | |
| | | ethanol | 360) | | | | | |
| | | | TMSA | 0.21M | | | 70 | |
| | | | EGDMA | 0.03M | | | 1, 5, 10 or | |
| | | | | | | | 15 | |

1-3. Coating with Silicon Dioxide Nanoparticles

The separator, to which the PEGMA, TMSA and EGDMA functional groups capable of bonding to inorganic oxide particles were introduced in in Example 1-2 above, was coated with inorganic oxide particles. The inorganic oxide particles used for coating in Examples 1-3 were silicon dioxide (SiO₂) nanoparticles.

First, a solution for casting was prepared by adding silicon dioxide to a 94:5 mixed solvent of ethanol and acetic acid at a concentration of 1 wt %. The separator to which the functional groups have been introduced was placed on a glass plate, and the prepared solution was poured on the glass plate and then cast to a thickness of 50 μm. Thereafter, the resulting separator was dried in an oven at a temperature of 50° C. for 12 hours and cleaned ultrasonically. The cleaned separator was subjected once more to the above-described casting process, thereby fabricating a Silicon dioxide (SiO₂) nanoparticle-coated separator (DPSG-SNP). The experimental conditions in Examples 1-3 are shown in Table 3 below.

TABLE 3

| | Inorganic | | SiO₂ | | Reaction |
|---|---|---|---|---|---|
| | oxide | Solvent | concentration | Temperature | time |
| Separator | particles | (wt %) | (wt %) | (° C.) | (hours) |
| DPSG | SiO₂ | EtOH: | 1 | 60 | 12 |
| | | acetic | | | |
| | | acid | | | |
| | | (94:5) | | | |

### Experimental Example 1

### Characterization of Separator Dip-Coated with DPVDF

### 1-1. Analysis of Surface Properties

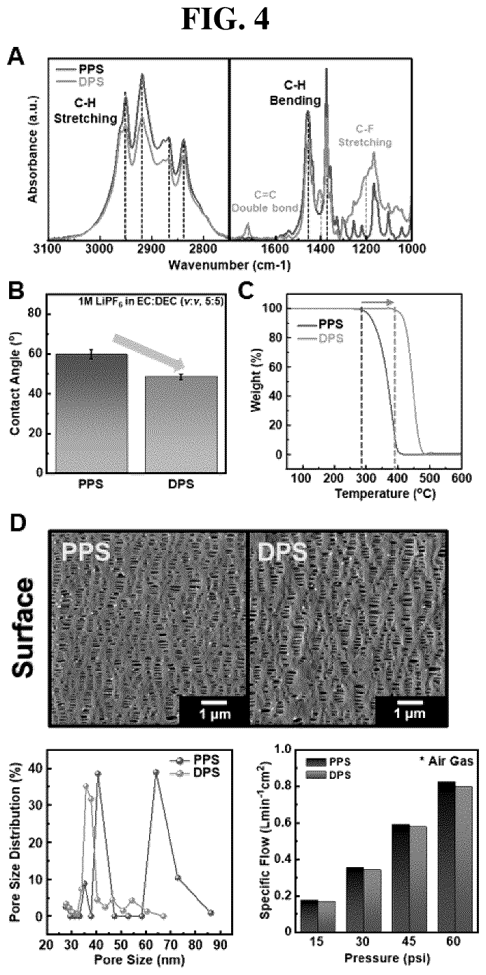

The surface properties of the separator (DPS) dip-coated with DPVDF in Example 1-1 and the polypropylene separator (PPS) not dip-coated with DPVDF were analyzed by FT-IR. The FT-IR was performed used model iS10 (ThermoFisher). FT-IR measurements were performed in ATR mode using dried films. As a result, it was confirmed that DPVDF was introduced to the DPS. More specifically, it was confirmed that the carbon-carbon double bond peak (˜1, 720 cm⁻¹) for DPVDF increased (FIG. 4A).

### 1-2. Analysis of Electrolyte Contact Angle

The electrolyte contact angles of the separator (DPS) dip-coated with DPVDF in Example 1-1 and the polypropylene separator (PPS) not dip-coated with DPVDF were analyzed. The electrolyte contact angle was measured using model Phoenix 300 (SEO), and was measured based on the contact angle between the separator and an electrolyte droplet using 5 μl of an electrolyte solution according to the ASTM D5946 method. The electrolyte solution refers to a solution obtained by adding lithium hexafluorophosphate (LiPF₆) to a 1:1 (v/v) solution of ethylene carbonate and diethyl carbonate at a concentration of 1 M.

As a result of Experimental Example 1-2, it was confirmed that the electrolyte contact angle of the PPS was 58.56°, the electrolyte contact angle of DPS was 48.93°, the electrolyte contact angle of DPSG was 29.22°, and the electrolyte contact angles of DPSG-SNPI and DPSG-SNPC were 6.53 and 6.63°, respectively (FIG. 4B). Therefore, the electrolyte contact angle was low in the order of DPSG-SNPI, DPSG-SNPC, DPSG, DPS, and PPS.

### 1-3. Analysis of Thermal Properties

The thermal properties of the separator (DPS) dip-coated with DPVDF in Example 1-1 and the polypropylene separator (PPS) not dip-coated with DPVDF were analyzed. The thermal properties were measured using a TGA 55 instrument (TA Instrument). More specifically, the thermal decomposition temperature of each of DPS and PPS was measured with increasing temperature. As a result of Experimental Example 1-3, it was confirmed that the thermal decomposition temperature of PPS was 310.79° C. at 5% Td and the thermal decomposition temperature of DPS was 413.11° C. at 5% Td (FIG. 4C.). Thus, it was confirmed that the thermal decomposition temperature of DPS was significantly higher than that of PPS, indicating that the thermal stability of the separator increased due to dip coating with DPVDF. The term “5% Td” means the temperature at which 5 wt % of the total weight is decomposed.

### 1-4. Analysis of Pore Shape and Size

The pore shape and size of each of the separator (DPS) dip-coated with DPVDF in Example 1-1 and the polypropylene separator (PPS) not dip-coated with DPVDF were analyzed. First, the pore shape was observed using an SEM microscope. Here, the SEM microscope used to observe the pore structure was model MIRA3 (TESCAN) and was used at 50,000× magnification. Thereafter, the pore size was analyzed using a porometer (Porolux 1000). More specifically, the pore size was analyzed using a gas liquid porometry method, which analyzes the pore size using the fed flow while increasing the pressure from 0 to 300 psi.

As a result of Experimental Example 1-4, it was confirmed that the average pore size of DPS was 45.59 nm and the average pore size of PPS was 38.67 nm. More specifically, it was confirmed that the specific flow of DPS was 0.8233 Lmin⁻¹cm² at 60 psi and the specific flow of PPS was 0.7964 Lmin⁻¹cm² at 60 psi (FIG. 4D).

### Experimental Example 2

### Characterization of Separator Depending on EGDMA Concentration

### 2-1. Analysis of FT-IR Peaks

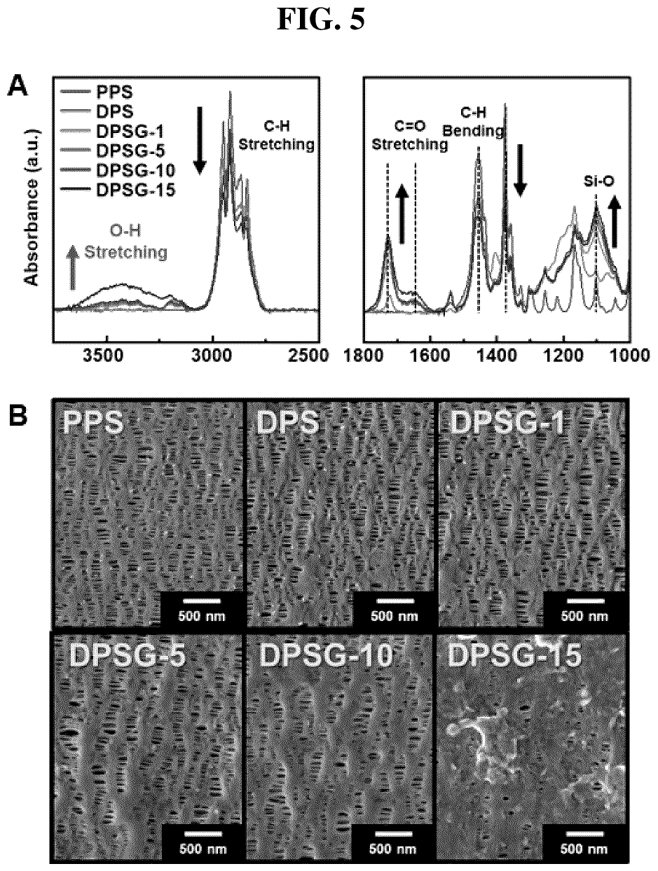

Experimental Example 2-1 was conducted to analyze FT-IR peaks depending on the concentrations of EGDMA used to fabricate separators. The separators used in Experimental Example 2-1 were fabricated in the same manner as in Example 1-2. However, in Example 1-2, EGDMA was used at a concentration of 0.03 M, but in Experimental Example 2-1, EGDMA was dissolved in an ethanol solvent at 0.003, 0.015, 0.03 and 0.045 M and used. The separators fabricated using EGDMA at concentrations of 0.003, 0.015, 0.03 and 0.045 M were named DPSG-1, DPSG-5, DPSG-10 and DPSG-15, respectively. In addition, DPS was prepared in the same manner as in Example 1-1. FT-IR analysis of PPS, DPS, DPSG-1, DPSG-5, DPSG-10, and DPSG-15 was performed in the same manner as in Experimental Example 1-1, and the results of the analysis are shown graphically in FIG. 5A. As a result of Experimental Example 2-1, it was confirmed that, as the concentration of EGDMA increased, O—H stretching, C═O stretching, and Si—O peaks increased, and C—H stretching and C—H bending peaks decreased (FIG. 5A).

### 2-2. Analysis of Pore Shape

Experimental Example 2-2 was conducted to analyze the pore shapes depending on the concentrations of EGDMA used to fabricate separators. PPS, DPS, DPSG-1, DPSG-5, DPSG-10, and DPSG-15 separators were fabricated in the same manner as in Experimental Example 2-1. The pore shapes of the separators were analyzed using an SEM microscope in the same manner as in Experimental Examples 1-4.

As a result of Experimental Example 2-2, pore clogging was not observed in up to DPSG-10, but was observed in DPSG-15 (FIG. 5B). Therefore, it is considered that DPSG-15 is unsuitable as a separator because its pores are clogged.

### 2-3. Analysis of Electrochemical Properties

Experimental Example 2-3 was conducted to analyze the electrochemical properties depending on the concentrations of EGDMA used to fabricate separators. In Experimental Example 2-3, electrolyte affinity, the resistance of the separator, and the resistance at the separator/electrode interface were analyzed. First, PPS, DPS, DPSG-1, DPSG-5, DPSG-10, and DPSG-15 separators were prepared in the same manner as in Experimental Example 2-1.

First, the electrolyte affinity of each of the PPS, DPS, DPSG-1, DPSG-5, DPSG-10, and DPSG-15 separators prepared above was measured by analyzing the electrolyte contact angle of each separator in Experimental Example 1-2. Next, to measure the resistance of each of the prepared PPS, DPS, DPSG-1, DPSG-5, DPSG-10, and DPSG-15 separators, coin cells consisting only of each separator and an electrolyte were fabricated and the resistance of the separator in each coin cell was measured using an SP-240 instrument (Biologic). Finally, to measure the resistance at the electrode interface with each of the prepared PPS, DPS, DPSG-1, DPSG-5, DPSG-10 and DPSG-15 separators, coin cells consisting of each separator, an electrolyte, a lithium metal anode, and a lithium iron phosphate cathode were fabricated and the resistance at the separator/electrode interface in the coin cell was analyzed using the SP-240 instrument.

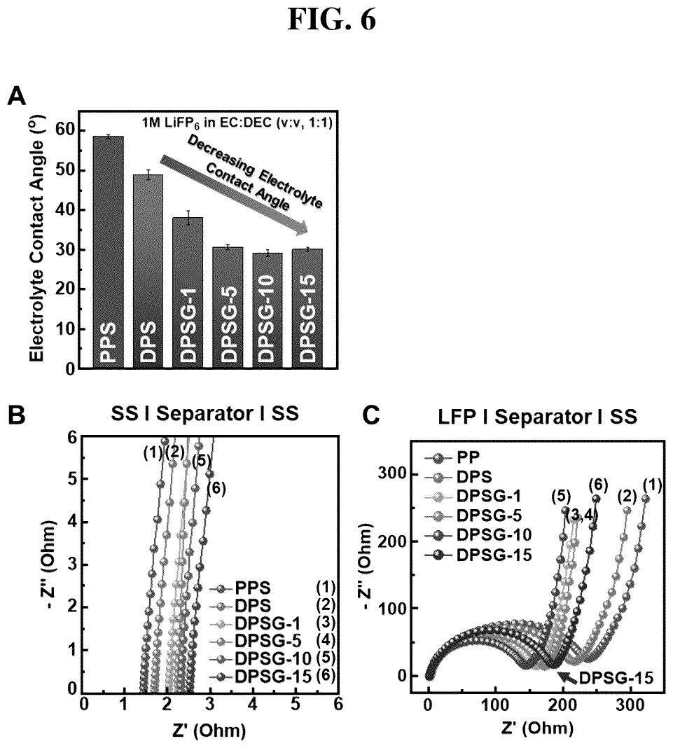

As a result of this Experimental Example 2-3, it was confirmed that, as the EGDMA concentration increased, the electrolyte contact angle decreased and the electrolyte affinity increased (FIG. 6A), and the resistance of the separator slightly decreased (FIG. 6B). Meanwhile, as the EGDMA concentration increased, the resistance at the separator/electrode interface decreased in DPSG-1, DPSG-5, and DPSG-10, but increased in DPSG-15 due to pore clogging (FIG. 6C). Therefore, based on the above results, it was confirmed that DPSG-10 (EGDMA 0.03 M) was the most desirable condition.

### Experimental Example 3

### Characterization of Separator Depending on Method of Coating with Inorganic Oxide Particles

### 3-1. Analysis of Thickness and Coating Uniformity of Separator

Experimental Example 3-1 was conducted to analyze the thickness and coating uniformity of the separator according to the method of coating with inorganic oxide particles. In Experimental Example 3-1, as coating methods, an immersion method and a casting method were used, and silicon dioxide (SiO₂) nanoparticles were used as inorganic oxide particles. The separator fabricated using the casting method was fabricated in the same manner as Example 1. The separator fabricated using the immersion method was fabricated by immersion the separator, to which the functional groups were introduced in the same manner as in Example 1, in an ethanol solution containing SiOs at a concentration of 1 wt %, and allowing the separator to react at 50° C. for 12 hours. The separator coated with silicon dioxide (SiO: ) nanoparticles (SNP) using the immersion method was named DPSG-SNPI, and the separator coated with SNP using the casting method was named DPSG-SNPC. The pore shape, thickness, and coating uniformity f each of the DPSG-SNPI and DPSG-SNPC separators were observed using an SEM microscope in the same manner as in Experimental Example 1-4.

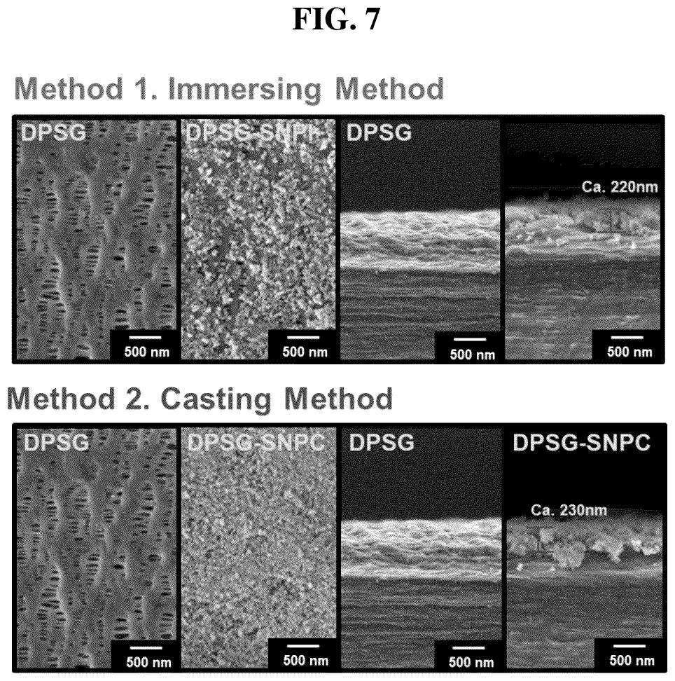

As a result, it was confirmed that the average thickness of DPSG-SNPI was 219. 649 nm, and the standard deviation for the thickness was 38.241 nm, whereas the average thickness of DPSG-SNPC was 234.649 nm, and the standard deviation for the thickness was 17.098 nm (FIG. 7). Therefore, it was confirmed that the SNP coating on the separator fabricated using the immersion method was non-uniform compared to the SNP coating on the separator fabricated using the casting method.

### 3-2. Analysis of Electrolyte Affinity

DPS was fabricated in the same manner as in Example 1-1, DPSG was fabricated in the same manner as in Example 1-2, and DPSG-SNPI and DPSG-SNPC were fabricated in the same manner as in Experimental Example 3-1. The electrolyte affinity of each of the fabricated PPS, DPS, DPSG, DPSG-SNPI and DPSG-SNPC separators was measured by analyzing the electrolyte contact angle of each separator in the same manner as in Experimental Example 1-2. Next, the electrolyte affinity of each of the PPS, DPS, DPSG, DPSG-SNPI, and DPSG-SNPC separators was analyzed by a wetting test. The wetting test was conducted by spraying 50 μl of an electrolyte onto each of the separators and after 30 seconds, 1 minute, 3 minutes, and 5 minutes, checking the degree to which the electrolyte was absorbed into the separator. Finally, the resistance at the separator/electrode interface was measured in the same manner as in Experimental Example 2-3.

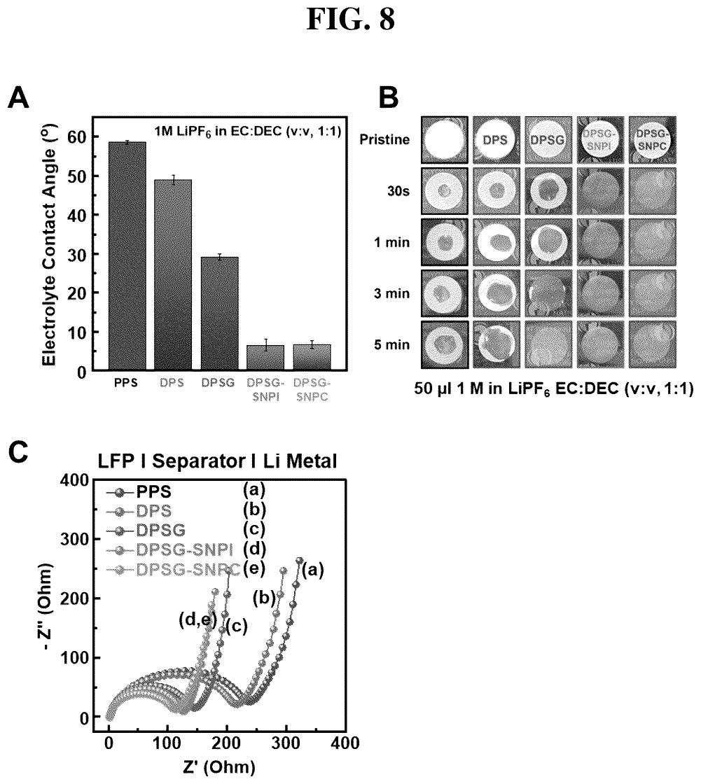

As a result of Experimental Example 3-2, it was confirmed that the electrolyte contact angle greatly decreased and the electrolyte affinity greatly increased in SNP-coated DPSG-SNPI and DPSG-SNPC compared to DPS and DPSG (FIG. 8A). In addition, the results of the wetting test showed that DPSG-SNPI and DPSG-SNPC were completely wet within 30 seconds compared to the other separators. However, the DPS separator was not completely wet until 5 minutes, and the DPSG separator was not completely wet at 3 minutes (FIG. 8B). Referring to FIGS. 8A and 8B, it was confirmed that electrolyte affinity greatly increased in DPSG-SNPI and DPSG-SNPC. In addition, the resistance at the interface further decreased in DPSG-SNPI and DPSG-SNPC compared to DPSG without SNP coating (FIG. 8C).

### Experimental Example 4

### Improvement in Thermal Stability of Separator by Coating with Inorganic Oxide Particles

Experimental Example 4 was conducted to evaluate the effect of coating with inorganic oxide particles on improving the thermal stability of the separator. DPS was fabricated in the same manner as in Example 1-1, DPSG was fabricated in the same manner as in Example 1-2, and DPSG-SNPI and DPSG-SNPC were fabricated in the same manner as in Experimental Example 3-1.

The thermal stability of each of the PPS, DPS, DPSG, DPSG-SNPI and DPSG-SNPC separators was measured by placing each separator in an oven at a temperature of 100, 120, 140, 160 or 180° C. for 30 minutes and then checking how much the separators had shrunk. In addition, the thermal decomposition temperature of each of the separators was measured in the same manner as in Experimental Example 1-3.

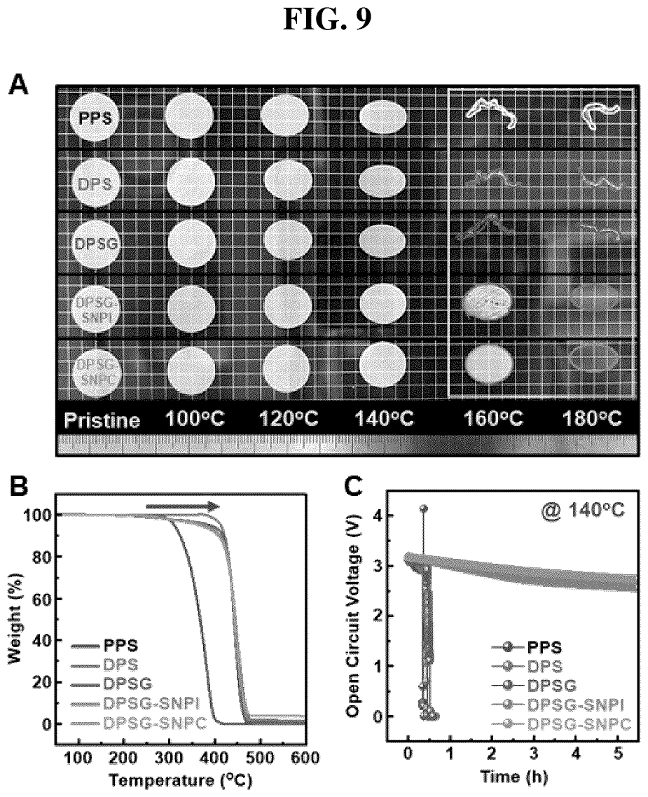

As a result of Experimental Example 4, it was confirmed that the thermal stability of the separator greatly increased due to coating with SNP. The PPS, DPS, DPSG, DPSG-SNPI and DPSG-SNPC separators were not deformed up to 100° C., but the shapes of PPS, DPS and DPSG were partially deformed at 120 to 140° C. In addition, it was confirmed that the shapes of the PPS, DPS, and DPSG separators were greatly deformed at 160° C. or above, but the shapes of DPSG-SNPI and DPSG-SNPC were not significantly deformed at a high temperature of 100 to 180° C., indicating that DPSG-SNPI and DPSG-SNPC had very improved thermal stability (FIG. 9A). It was confirmed that the thermal decomposition temperatures of the separators were almost similar except for PPS (FIG. 9B). In particular, referring to FIG. 9C, it was confirmed that the SNP-coated separator maintained the voltage at 140° C. for a long time, indicating that the SNP-coated separator had significantly improved thermal stability.

### Experimental Example 5

### Analysis of Lithium-Ion Battery Charge/Discharge Performance of Separator Coated with Inorganic Oxide Particles

Experimental Example 5 was conducted to analyze the lithium-ion battery charge/discharge performance of the separator coated with inorganic oxide particles. DPS was fabricated in the same manner as in Example 1-1, DPSG was fabricated in the same manner as in Example 1-2, and DPSG-SNPI and DPSG-SNPC were fabricated in the same manner as in Experimental Example 3-1.

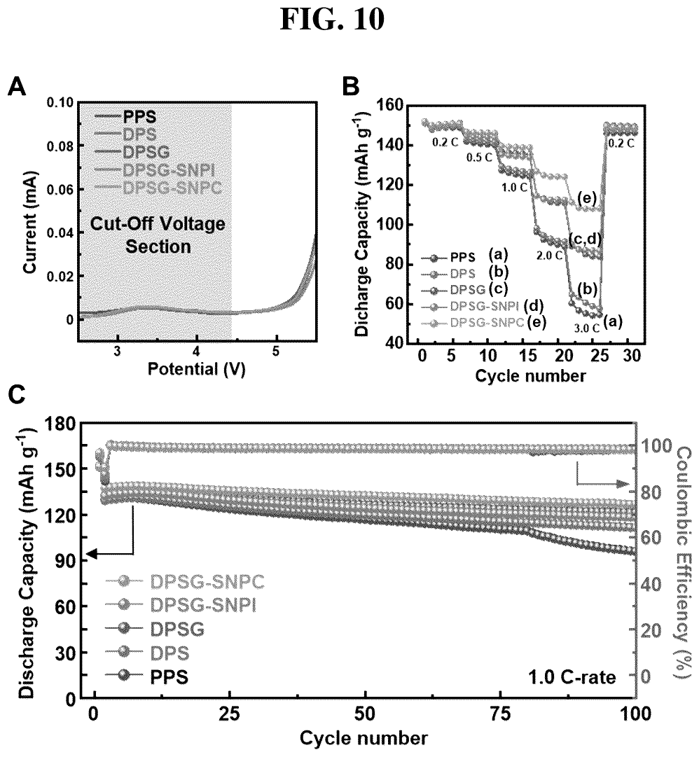

First, the battery charge/discharge performance of each of the PPS, DPS, DPSG, DPSG-SNPI, and DPSG-SNPC separators was analyzed by linear sweep voltammetry (LSV). More specifically, coin cells consisting only of each separator, a lithium metal anode, and an electrolyte were fabricated and the amount of current generated when the potential was increased from 2.5 mV/s to 5.5 mV/s was measured. An increase in the amount of current means that an electrochemical reaction occurred. The results are shown graphically in FIG. 10A.

Lithium-ion batteries consisting of a lithium metal anode, an electrolyte, each separator, and a lithium iron phosphate cathode were fabricated, and the performance of the battery was evaluated depending on the charge/discharge rate. The results are shown graphically in FIG. 10B. In addition, lithium-ion batteries consisting of lithium metal, an anode, an electrolyte, and a lithium iron phosphate cathode were fabricated and tested for 100 cycles at a rate of 1.0 C. The results are graphically shown in FIG. 10C.

As a result of Experimental Example 5, it was confirmed that, when the electrochemical stability of the PPS, DPS, DPSG, DPSG-SNPI, and DPSG-SNPC was evaluated by linear sweep voltammetry (LSV), the SNP-coated DPSG-SNPI and DPSG-SNPC separators were electrochemically stable. More specifically, it was confirmed that the separators showed no reaction in the cut-off voltage section (2.5 to 4.2 V), indicating that they are electrochemically stable within the charge/discharge voltage range (FIG. 10A).

Referring to FIG. 10B, the battery charge/discharge performance of DPS was superior to that of PPS, and the charge/discharge performance of DPSG was superior to that of DPS. In particular, the battery charge/discharge performance of DPSG-SNPC was the best, but DPSG-SNPI showed charge/discharge performance similar to that of DPSG (FIG. 10B). Therefore, it was confirmed that the casting method was more effective than the immersion method in coating with SNP.

Referring to FIG. 10C, it was confirmed that, even in the long-term test conducted to test the charge/discharge performance from 0 to 100 cycles, the charge/discharge performance of DPSG-SNPC was the best.

### Experimental Example 6

### Effect of Coating with Inorganic Oxide Particles on Lithium Dendrite Resistance

Experimental Example 6 was conducted to analyze the lithium dendrite resistance of the separator coated with inorganic oxide particles. DPS was fabricated in the same manner as in Example 1-1, DPSG was fabricated in the same manner as in Example 1-2, and DPSG-SNPI and DPSG-SNPC were fabricated in the same manner as in Experimental Example 3-1.

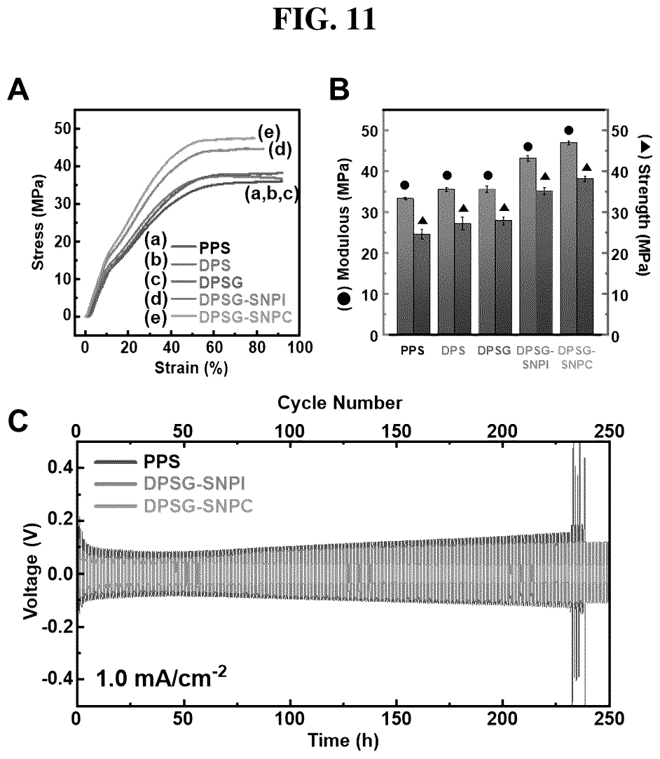

First, the physical properties of the PPS, DPS, DPSG, DPSG-SNPI and DPSG-SNPC separators were measured based on the stress-strain curves of the separators using a universal material tester (model AGX, Shimadzu). The results are graphically shown in FIGS. 11A and 11B. In addition, the lithium dendrite resistance of each of the separators was measured. For measurement of the lithium dendrite resistance, symmetrical cells comprising a lithium metal cathode and a lithium metal anode were fabricated, and then a current of 1.0 mA/cm² was repeatedly applied across the cathode and the anode for 10 minutes and the lithium dendrite resistance was measured.

Referring to FIG. 11C, it was confirmed that, in the case of PPS, driving of the cell stopped due to a short circuit at about 230 hours in the lithium metal test, but in the case of the SNP-coated DPSG-SNPI and DPSG-SNPC, the cells could be stably driven for over 250 hours.

### Example 2

### Fabrication of Polymer Separator Coated with Aluminum Oxide Nanoparticles

Example 2 was performed to fabricate a polymer separator coated with aluminum oxide (Al₂O₃) nanoparticles. In Example 2, a polypropylene (PP) separator was dip-coated with DPVDF in the same manner as in Example 1-1, and functional groups capable of bonding to aluminum oxide nanoparticles were introduced to the separator dip-coated with DPVDF in the same manner as in Example 1-2.

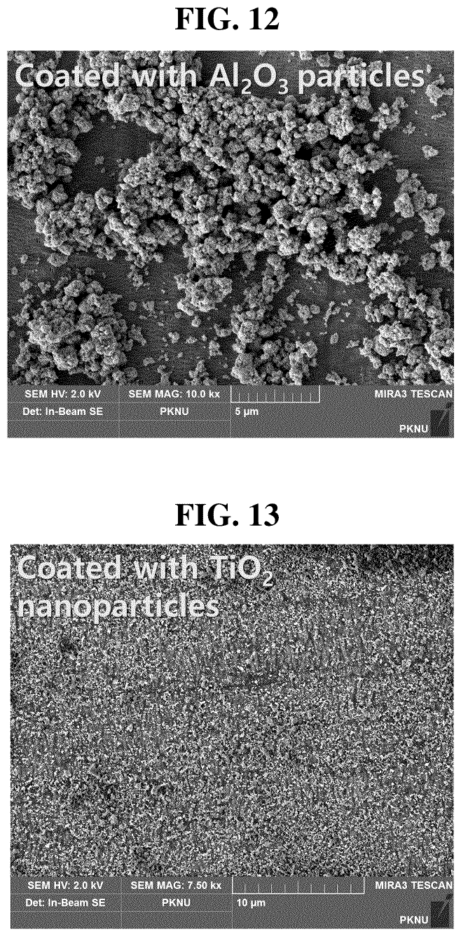

In order to coat the separator, to which the functional groups have been introduced, with aluminum oxide nanoparticles, a solution for casting was prepared by adding aluminum oxide to a 94:5 mixed solvent of ethanol and acetic acid at a concentration of 1 wt %. The separator to which the functional groups have been introduced was placed on a glass plate, and the prepared solution was poured on the glass plate and then cast to a thickness of 50 μm. Thereafter, the resulting separator was dried in an oven at a temperature of 50° C. for 12 hours and cleaned ultrasonically. The cleaned separator was subjected once more to the above-described casting process, thereby fabricating a separator coated with aluminum oxide nanoparticles. The separator fabricated in Example 2 was observed under an SEM microscope, and the results of the observation are shown in FIG. 12.

### Example 3

### Fabrication of Polymer Separator Coated with Titanium Dioxide Nanoparticles

Example 3 was performed to fabricate a polymer separator coated with titanium dioxide (TiO₂) nanoparticles. In Example 3, a polypropylene (PP) separator was dip-coated with DPVDF in the same manner as in Example 1-1, and functional groups capable of bonding to titanium dioxide nanoparticles were introduced to the separator dip-coated with DPVDF in the same manner as in Example 1-2.

In order to coat the separator, to which the functional groups have been introduced, with titanium dioxide nanoparticles, a solution for casting was prepared by adding titanium dioxide to a 94:5 mixed solvent of ethanol and acetic acid at a concentration of 1 wt %. The separator to which the functional groups have been introduced was placed on a glass plate, and the prepared solution was poured on the glass plate and then cast to a thickness of 50 μm. Thereafter, the resulting separator was dried in an oven at a temperature of 50° C. for 12 hours and cleaned ultrasonically. The cleaned separator was subjected once more to the above-described casting process, thereby fabricating a separator coated with titanium dioxide nanoparticles. The separator fabricated in Example 3 was observed under an SEM microscope, and the results of the observation are shown in FIG. 13.

While the present disclosure has been described with reference to the particular illustrative embodiments, it will be understood by those skilled in the art that the present disclosure may be embodied in other specific forms without departing from the technical spirit or essential characteristics of the present disclosure. Therefore, the embodiments described above are considered to be illustrative in all respects and not restrictive.

1. A polymer separator comprising a porous polymer substrate and a coating layer formed on at least one surface of the porous polymer separator, wherein the coating layer comprises: a functional group bonded to double bond-containing PVDF (DPVDF); and inorganic oxide particles bonded to the functional group.

2. The polymer separator of claim 1, wherein the functional group is at least one compound selected from the group consisting of compounds represented by Formulas 1 to 4 below: 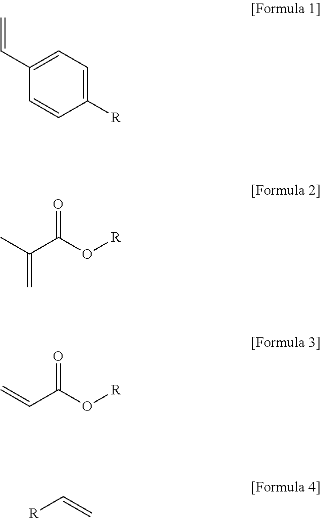
wherein R is

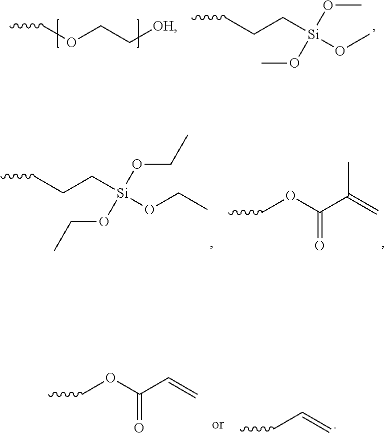

3. The polymer separator of claim 1, wherein the porous polymer substrate comprises at least one selected from the group consisting of polyethylene (PE), polypropylene (PP), cellulose acetate, polyvinylidene fluoride (PVDF), polyethersulfone (PES), and polyethylene terephthalate (PET).

4. The polymer separator of claim 1, wherein the inorganic oxide particles comprise at last one type of inorganic oxide particles selected from the group consisting of silicon dioxide (SiO₂) nanoparticles, aluminum oxide (Al₂O₃) nanoparticles, and titanium dioxide (TiO₂) nanoparticles.

5. The polymer separator of claim 1, wherein the coating layer has a thickness of 180 to 260 nm.

6. An electrochemical device comprising the polymer separator of claim 1.

7. The electrochemical device of claim 6, wherein the electrochemical device is a lithium-ion battery.

8. A method for fabricating a polymer separator, comprising steps of:
dip-coating a porous polymer substrate with double bond-containing PVDF (DPVDF);
introducing at least one functional group, selected from the group consisting of polyethyleneglycol methacrylate (PEGMA), 3-(trimethoxysilyl)propyl acrylate (TMSA), and ethylene glycol dimethacrylate (EGDMA), to the dip-coated substrate; and
coating the substrate, to which the functional group has been introduced, with inorganic oxide particles.

9. The method of claim 8, wherein the step of introducing the functional group is a step of immersing the dip-coated substrate in a solution containing polyethyleneglycol methacrylate (PEGMA), 3-(trimethoxysilyl)propyl acrylate (TMSA), and ethylene glycol dimethacrylate (EGDMA), wherein the solution is a solution containing the PEGMA at a concentration of 0.05 to 0.14 M, the TMSA at a concentration of 0.1 to 0.3 M, and the EGDMA at a concentration of 0.02 to 0.04 M.

10. The method of claim 8, wherein the step of coating the substrate with the inorganic oxide particles comprises casting a solution containing the inorganic oxide particles onto the substrate to which the functional group has been introduced.

11. The method of claim 8, wherein the porous polymer substrate comprises at least one selected from the group consisting of polyethylene (PE), polypropylene (PP), cellulose acetate, polyvinylidene fluoride (PVDF), polyethersulfone (PES), and polyethylene terephthalate (PET).

12. The method of claim 8, wherein the inorganic oxide particles comprise at last one type of inorganic oxide particles selected from the group consisting of silicon dioxide (SiO₂) nanoparticles, aluminum oxide (Al₂O₃) nanoparticles, and titanium dioxide (TiO₂) nanoparticles.
